(19) United States
(12) Patent Application Publication
(10) Pub. No.: US 2006/0147685 A1
(43) Pub. Date: Jul. 6, 2006

(54) Multilayer film structure with higher processability

(75) Inventors: Prasad Shrikrishna Potnis, Duluth, GA (US); Tamara Lee Mace, Marietta, GA (US); John Edmond Flood, Cypress, TX (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 11/062,776

(22) Filed: Feb. 22, 2005

Related U.S. Application Data
(60) Provisional application No. 60/640,801, filed on Dec. 30, 2004.

(51) Int. Cl. B32B 7/02

(52) U.S. Cl. 428/212

(57) ABSTRACT

A breathable elastic multilayered film includes at least two skin layers each including a low viscosity polymer, and a filler, wherein each of the skin layers comprises between about 1 and 25 percent of the volume of the multilayered film. The film also includes at least one core layer including a high viscosity polymer, a carrier resin and a filler. The at least one core layer comprises between about 50 and 98 percent volume of the multilayered film, and is sandwiched by the two skin layers.

### RELATED APPLICATIONS

The present application claims priority to U.S. Provisional Application Ser. No. 60/640,801, which was filed on Dec. 30, 2004.

### FIELD OF THE INVENTION

The present invention relates to breathable elastic films and laminates made therefrom, manufacturing methods for making such films, and disposable product applications of such films.

### BACKGROUND OF THE INVENTION

Film and film/nonwoven laminates are used in a wide variety of applications, not the least of which is as elastic attachment ears and outercovers/backsheets for limited use or disposable products including personal care absorbent articles such as diapers, training pants, swimwear, incontinence garments, feminine hygiene products, wound dressings, bandages, mortuary products and the like. Such materials also have applications as product waist and leg elastics. Film/nonwoven laminates also have applications in the protective cover area, such as car, boat or other object cover components, tents (outdoor recreational covers), agricultural fabrics (row covers) and in the health care area in conjunction with such products as surgical drapes, hospital gowns, fenestration reinforcements and veterinary products. Additionally, such materials have applications in other apparel for clean room and health care settings.

In the personal care area in particular, there has been an emphasis on the development of film laminates which have good barrier properties, especially with respect to liquids, as well as good aesthetic and tactile properties such as hand and feel. There has been a further emphasis on the “stretch” comfort of such laminates, that is, the ability of the laminates to “give” as a result of the product utilizing such laminates being elongated in use, but also to provide a necessary level of vapor permeability to maintain the skin health of a product user.

It is known that breathable polymeric films may be made by utilizing a variety of thermoplastic polymers in combinations with filler particles. These and other desired components, such as additives can be mixed together, heated and then extruded into a monolayer or multilayer filled film. Examples are described in WO 96/19346 to McCormack et al. which is incorporated by reference herein in its entirety. The filled film may be made by any one of a variety of film forming processes known in the art such as, for example, by using either cast or blown film equipment. The thermoplastic film can then be stretched either alone or as part of a laminate to impart breathability or other desired properties. The films are often stretched in a machine direction orienter-type apparatus, or other stretching device, which stretches the film, thereby creating a pore-like matrix in the film body at the locations of the filler particles. While such breathable films and film/laminates are known to be used as personal care outercover materials, thereby allowing the personal care products to “breathe” and making such products more comfortable to wear, there has been difficulty producing such materials from “elastic” -type materials. Often, such breathable films are produced from polyolefin materials that can be extended without the ability to retract. While such film materials offer the comfort of air/gas circulation, and may offer the ability to extend only, they may limit or restrict movement of a user wearing articles made from such materials. If they are extended to a great extent, they may sag within the product, since they lack the ability to retract, and may in some circumstances, contribute to leakage. Such sagging sacrifices both the aesthetic appearance and the comfort level of the product.

It is has been previously found that if filler is placed in elastic polymer film formulations, the pores that are formed around the filler particles during a film formation stretch operation (such as in a machine direction orienter) are temporary, and close after stretching, as a result of the elastic attributes of the polymer component in the film. Without the pore structures, the film becomes non-breathable. It therefore is widely recognized that properties relating to elasticity and breathability are often conflicting. As a result of these attributes of highly elastic polymers, when breathable and elastic film materials have been sought for personal care product applications, manufacturers have until recently turned to inherently breathable elastic materials, that allow gasses to pass or diffuse through their structures, without the necessity for pores (which risk collapse). Such inherently breathable films may be more costly than other material films, often do not provide the level of breathability desired for consumer product applications, and often have to be fairly thin in order to achieve an acceptable level of breathability. Such thin films often lack the requisite strength/tear strength characteristics desired in personal care products.

Breathable elastic films which overcome such difficulties have now been developed. For example, such are described in U.S. Ser. No. 10/703,761 titled Microporous Breathable Elastic Films, Methods of Making Same, and Limited Use or Disposable Product Applications, filed Nov. 7, 2003 which is hereby incorporated by reference in its entirety. While such films are effective in providing both a desired level of breathability and elastic performance, they offer manufacturing challenges. For example, it has been found that as a result of higher viscosity polymers employed in such films, such films pose extrusion difficulties and other manufacturing challenges. Such high viscosity polymers require high processing heat and high shear rates which lead to shortened extrusion die life. There are therefore needs for such breathable elastic films which may be more easily processed and which structure do not sacrifice desired levels of elastic performance and breathability.

Typically, film and film laminate materials that are used in personal care product applications are manufactured in one of two ways. In a first process, such film materials are manufactured in-line, that is, as part of a larger integrated laminate or end-product manufacturing process, where at least some of the product components are manufactured in a continuous process which allows them to be integrated into the larger product. Films made in the in-line process (either cast or blown) are immediately moved from a film forming station to further processing stations. In an in-line process there is no concern over film storage or transport conditions since there is little to no idle time between film formation and film usage/integration.

In the second type of film manufacturing process, films are formed and then rolled/wound for storage. This process is used either when the film forming station is in a different location from the other product component processing stations, or alternatively when excess film is produced that is not needed immediately. With this process, the film is placed on a roll and stored for several days or even months. Such film rolls may be stored under less than ideal conditions, that is, in facilities without climate or humidity control. In such storage facilities, the stored films may encounter vast fluctuations in temperature. Such film rolls may have to be transported to alternate processing facilities, quite a distance from the original film production facility. Such films may have to be further processed at various locations prior to being incorporated into a laminate or end product.

It has been found that stored films, and in particular stored elastic films, tend to roll block during storage. That is, such films tend to stick to themselves when placed under the normal storage pressure of a roll and also when stored in changing temperature and humidity conditions. Such sticking (roll blocking) renders the film roll unusable, since it cannot be unwound easily, or ruptures during an unwind operation, ultimately leading to material waste and higher processing costs. Even films that provide high breathability and stretch will be rendered useless if stored under less than ideal conditions. It would therefore be desirable to develop an elastic film that can be easily stored and transported under a variety of environmental conditions, and that can be easily unwound at a later date following film formation. It is to such needs that the present invention is also directed.

### SUMMARY OF THE INVENTION

A breathable elastic multilayered film includes at least two skin layers including a low viscosity polymer, and optionally a filler, wherein each of the skin layers comprises between about 1 and 25 percent of the volume of the multilayered film. The film further includes at least one core layer including a high viscosity polymer, a carrier resin and a filler. The core layer(s) comprise between about 50 and 98 percent volume of the multilayered film, and are sandwiched by the at least two skin layers. Alternatively such film may be non-breathable. In such embodiment, the filler and carrier may be removed.

In an alternative embodiment, the skin layers comprise between about 2 and 25 percent of the volume of the multilayered film and the core layer comprises between about 50 and 96 percent volume of the multilayered film. In still a further alternative embodiment, each of the skin layers comprise between about 1 and 2 percent volume of the film.

In still a further alternative embodiment, the low viscosity polymer demonstrates an MI of between about 6 and 25, and the high viscosity polymer demonstrates an MI of between about less than 1 to 4. In still a further alternative embodiment, the core layer includes a high viscosity polymer and a lower viscosity polymer. In still a further alternative embodiment, the higher viscosity polymer in the core layer and the lower viscosity polymer in the core layer are present in a weight percent ratio of between about 3:1 to 4:1.

In yet another alternative embodiment of the invention, the difference between MI of the low viscosity polymer and high viscosity polymer is at least about 5 MI. In still another alternative embodiment, the difference between the MI of the low viscosity polymer and high viscosity polymer is at least about 10 MI. In yet another alternative embodiment of the invention, the difference between MI of the low viscosity polymer and high viscosity polymer is at least about 15 MI.

In yet another alternative embodiment of the invention, the skin layers include filler in a percentage of between about 10 and 50 weight percent. In yet another alternative embodiment of the invention, the core layer is comprised of two outer core layers and an inner core layer sandwiched between the two outer core layers. In another embodiment of the invention, the outer core layers include a low viscosity polymer (elastomer) and the inner core layer includes a high viscosity polymer (elastomer).

In still a further alternate embodiment of the invention, a breathable elastic multilayered film (desirably at least 5 layers) includes at least two skin layers including a low viscosity polymer, and a filler, wherein each of the skin layers comprises between about 1 and 25 percent of the volume of said multilayered film. Alternatively, the skin layers each comprise between about 1 and 2 percent of the volume of the film. The film also includes one inner core layer including a high viscosity polymer, a carrier resin and a filler. The inner core layer comprises between about 40 and 85 percent volume of the multilayered film. Alternatively, the inner core layer comprises between about 50 and 85 percent volume of the multilayered film. Still alternatively, the inner core layer comprises between about 40 and 50 volume percent of the film. The film also includes two outer core layers sandwiching the inner core layer, with each of the outer core layers being positioned in the multilayered film immediately subjacent to one of the skin layers. The outer core layers include a low viscosity polymer and each comprise between about 6 and 25 percent volume of the multilayered film (for a total volume percent for the two outer core layers of between about 12 and 50 percent).

### BRIEF DESCRIPTION OF THE FIGURES

The invention will be better understood by reference to the following description of embodiments of the invention taken in conjunction with the accompanying drawings, wherein:

FIG. 1 is a cross-sectional view of a film made in accordance with one embodiment of the invention.

FIG. 2 is a cross-sectional view of a film/laminate made in accordance with one embodiment of the invention.

FIG. 3 is a schematic of a process used to make a film and laminate in accordance with one embodiment of the invention.

FIG. 4 is a drawing of a diaper made in accordance with one embodiment of the invention.

FIG. 5 is a drawing of a training pant made in accordance with one embodiment of the invention.

FIG. 6 is a drawing of an absorbent underpant made in accordance with the invention

FIG. 7 is a drawing of a feminine hygiene product made in accordance with one embodiment of the invention.

FIG. 8 is a drawing of an adult incontinence product made in accordance with one embodiment of the invention.

FIG. 9 is a cross-sectional view of a film made in accordance with one embodiment of the invention.

### DETAILED DESCRIPTION OF REPRESENTATIVE EMBODIMENTS

### Definitions

As used herein, the term “personal care product “means diapers, training pants, swimwear, absorbent underpants, adult incontinence products, and feminine hygiene products, such as feminine care pads, napkins and pantiliners.

As used herein the term “protective outer wear” means garments used for protection in the workplace, such as surgical gowns, hospital gowns, masks, and protective coveralls.

As used herein, the term “protective cover” means covers that are used to protect objects such as for example car, boat and barbeque grill covers, as well as agricultural fabrics.

As used herein the terms “polymer” and “polymeric” generally include but are not limited to, homopolymers, copolymers, such as for example, block, graft, random and alternating copolymers, terpolymers, etc. and blends and modifications thereof. Furthermore, unless otherwise specifically limited, the term “polymer” includes all possible spatial configurations of the molecule. These configurations include, but are not limited to isotactic, syndiotactic and random symmetries.

As used herein, the terms “machine direction” or MD means the length of a fabric in the direction in which it is produced. The terms “cross machine direction,” “cross directional,” “cross-direction”, or CD mean the width of fabric, i.e. a direction generally perpendicular to the MD.

As used herein, the term “nonwoven web” means a polymeric web having a structure of individual fibers or threads which are interlaid, but not in an identifiable, repeating manner. Nonwoven webs have been, in the past, formed by a variety of processes such as, for example, meltblowing processes, spunbonding processes, hydroentangling, air-laid and bonded carded web processes.

As used herein, the term “bonded carded webs” refers to webs that are made from staple fibers which are usually purchased in bales. The bales are placed in a fiberizing unit/picker which opens the bale from the compact state and separates the fibers. Next, the fibers are sent through a combining or carding unit which further breaks apart and aligns the staple fibers in the machine direction so as to form a machine direction-oriented fibrous non-woven web. Once the web has been formed, it is then bonded by one or more of several bonding methods. One bonding method is powder bonding wherein a powdered adhesive is distributed throughout the web and then activated, usually by heating the web and adhesive with hot air. Another bonding method is pattern bonding wherein heated calendar rolls or ultrasonic bonding equipment is used to bond the fibers together, usually in a localized bond pattern through the web and/or alternatively the web may be bonded across its entire surface if so desired. When using bicomponent staple fibers, through-air bonding equipment is, for many applications, especially advantageous.

As used herein the term “spunbond” refers to small diameter fibers which are formed by extruding molten thermoplastic material as filaments from a plurality of fine, usually circular capillaries of a spinneret with the diameter of the extruded filaments being rapidly reduced as by for example in U.S. Pat. No. 4,340,563 to Appel et al., and U.S. Pat. No. 3,692,618 to Dorschner et al., U.S. Pat. No. 3,802,817 to Matsuki et al., U.S. Pat. No. 3,338,992 and 3,341,394 to Kinney, and U.S. Pat. No. 3,542,615 to Dobo et al., which are each incorporated by reference in their entirety herein.

As used herein the term “meltblown” means fibers formed by extruding a molten thermoplastic material through a plurality of fine, usually circular die capillaries as molten threads or filaments into converging high velocity gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, in various patents and publications, including NRL Report 4364, “Manufacture of Super-Fine Organic Fibers” by B. A. Wendt, E. L. Boone and D. D. Fluharty; NRL Report 5265, “An Improved Device For The Formation of Super-Fine Thermoplastic Fibers” by K. D. Lawrence, R. T. Lukas, J. A. Young; and U.S. Pat. No. 3,849,241, issued Nov. 19, 1974, to Butin, et al., the patent being incorporated by reference hereto in its entirety.

As used herein the term “sheet” or “sheet material” refers to woven materials, nonwoven webs, polymeric films, polymeric scrim-like materials, and polymeric foam sheeting.

The basis weight of nonwoven fabrics is usually expressed in ounces of material per square yard (osy) or grams per square meter (g/m² or gsm) and the fiber diameters useful are usually expressed in microns. (Note that to convert from osy to gsm, multiply osy by 33.91). Film thicknesses may also be expressed in microns.

As used herein the term “laminate” refers to a composite structure of two or more sheet material layers that have been adhered through a bonding step, such as through adhesive bonding, thermal bonding, point bonding, pressure bonding, extrusion coating or ultrasonic bonding.

As used herein, the term “elastomeric” shall be interchangeable with the term “elastic” and refers to sheet material which, upon application of a stretching force, is stretchable in at least one direction (such as the CD direction), and which upon release of the stretching force contracts/returns to approximately its original dimension. For example, a stretched material having a stretched length which is at least 50 percent greater than its relaxed unstretched length, and which will recover to within at least 50 percent of its elongation (the elongation being the stretched length subtracting the relaxed length) upon release of the stretching force. A hypothetical example would be a one (1) inch sample of a material which is stretchable to at least 1.50 inches and which, upon release of the stretching force, will recover to a length of not more than 1.25 inches. Desirably, such elastomeric sheet contracts or recovers up to 50 percent of the stretch length in the cross machine direction using a cycle test as described herein to determine percent set. Even more desirably, such elastomeric sheet material recovers up to 80 percent of the stretch length in the cross machine direction using a cycle test as described. Even more desirably, such elastomeric sheet material recovers greater than 80 percent of the stretch length in the cross machine direction using a cycle test as described. Desirably, such elastomeric sheet is stretchable and recoverable in both the MD and CD directions. For the purposes of this application, values of load loss and other “elastomeric functionality testing” have been generally measured in the CD direction, unless otherwise noted. Unless otherwise noted, such test values have been measured at 50 percent elongation on a 70 percent total elongation cycle (as described further in the test method section).

As used herein, the term “elastomer” shall refer to a polymer which is elastomeric.

As used herein, the term “thermoplastic” shall refer to a polymer which is capable of being melt processed.

As used herein, the term “inelastic” or “nonelastic” refers to any material which does not fall within the definition of “elastic” above.

As used herein, the term “breathable” refers to a material which is permeable to water vapor. The water vapor transmission rate (WVTR) or moisture vapor transfer rate (MVTR) is measured in grams per square meter per 24 hours, and shall be considered equivalent indicators of breathability. The term “breathable” desirably refers to a material which is permeable to water vapor having a minimum WVTR (water vapor transmission rate) of desirably about 100 g/m²/24 hours. Even more desirably, such material demonstrates breathability greater than about 300 g/m²/24 hours. Still even more desirably, such material demonstrates breathability greater than about 1000 g/m²/24 hours.

The WVTR of a fabric, in one aspect, gives an indication of how comfortable a fabric would be to wear. WVTR is measured as indicated below. Often, personal care product applications of breathable barriers desirably have higher WVTRs and breathable barriers of the present invention can have WVTRs exceeding about 1,200 g/m²/24 hours, 1,500 g/m²/24 hours, 1,800 g/m²/24 hours or even exceeding 2,000 g/m²/24 hours.

As used herein, the term “multilayer laminate” means a laminate including a variety of different sheet materials. For instance, a multi-layered laminate may include some layers of spunbond and some meltblown such as a spunbond/meltblown/spunbond (SMS) laminate and others as disclosed in U.S. Pat. No. 4,041,203 to Brock et al., U.S. Pat. No. 5,169,706 to Collier, et al., U.S. Pat. No. 5,145,727 to Potts et al., U.S. Pat. No. 5,178,931 to Perkins et al., and U.S. Pat. No. 5,188,885 to Timmons et al., each incorporated by reference in its entirety. Such a laminate may be made by sequentially depositing onto a moving forming belt first a spunbond fabric layer, then a meltblown fabric layer and last another spunbond layer and then bonding the laminate. Alternatively, the fabric layers may be made individually, collected in rolls, and combined in a separate bonding step or steps. Multilayer laminates may also have various numbers of meltblown layers or multiple spunbond layers in many different configurations and may include other materials like films or coform materials, e.g. SMMS, SM and SFS.

As used herein, the term “coform” means a process in which at least one meltblown diehead is arranged near a chute through which other materials are added to the web while it is forming. Such other materials may be pulp, superabsorbent particles, cellulosic fibers or staple fibers, for example. Coform processes are shown in commonly assigned U.S. Pat. No. 4,818,464 to Lau and U.S. Pat. No. 4,100,324 to Anderson et al., each incorporated by reference in its entirety.

As used herein, the term “conjugate fibers” refers to fibers which have been formed from at least two polymers extruded from separate extruders but spun together to form one fiber. Conjugate fibers are also sometimes referred to as multicomponent or bicomponent fibers. The polymers are usually different from each other though conjugate fibers may be monocomponent fibers. The polymers are arranged in substantially constantly positioned distinct zones across the cross-section of the conjugate fibers and extend continuously along the length of the conjugate fibers. The configuration of such conjugate fiber may be, for example, a sheath/core arrangement wherein one polymer is surrounded by another or may be a side by side arrangement, a pie arrangement or an “islands-in-the-sea” arrangement. Conjugate fibers are taught in U.S. Pat. No. 5,108,820 to Kaneko et al., U.S. Pat. No. 4,795,668 to Krueger et al., and U.S. Pat. No. 5,336,552 to Strack et al. Conjugate fibers are also taught in U.S. Pat. No. 5,382,400 to Pike et al., and may be used to produce crimp in the fibers by using the differential rates of expansion and contraction of the two or more polymers. For two component fibers, the polymers may be present in varying desired ratios. The fibers may also have shapes such as those described in U.S. Pat. No. 5,277,976 to Hogle et al., U.S. Pat. No. 5,466,410 to Hills and U.S. Pat. Nos. 5,069,970 and 5,057,368 to Largman et al., which describe fibers with unconventional shapes.

As used herein the term “thermal point bonding” involves passing a fabric or web of fibers to be bonded between a heated calender roll and an anvil roll. The calender roll is usually, though not always, patterned in some way so that the entire fabric is not bonded across its entire surface, and the anvil roll is usually flat. As a result, various patterns for calender rolls have been developed for functional as well as aesthetic reasons. One example of a pattern has points and is the Hansen Pennings or “H&P” pattern with about a 30% bond area with about 200 bonds/square inch as taught in U.S. Pat. No. 3,855,046 to Hansen and Pennings, incorporated herein by reference in its entirety. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5%. Another typical point bonding pattern is the expanded Hansen Pennings or “EHP” bond pattern which produces a 15% bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15%. Yet another common pattern is the C-Star pattern which has a bond area of about 16.9%. The C-Star pattern has a cross-directional bar or “corduroy” design interrupted by shooting stars. Other common patterns include a diamond pattern with repeating and slightly offset diamonds with about a 16% bond area and a wire weave pattern looking as the name suggests, e.g. like a window screen pattern having a bond area in the range of from about 15% to about 21% and about 302 bonds per square inch. Typically, the percent bonding area varies from around 10% to around 30% of the area of the fabric laminate web. As is well known in the art, the spot bonding holds the laminate layers together as well as imparts integrity to each individual layer by bonding filaments and/or fibers within each layer.

As used herein, the term “ultrasonic bonding” means a process performed, for example, by passing the fabric between a sonic horn and anvil roll as illustrated in U.S. Pat. No. 4,374,888 to Bornslaeger, incorporated by reference herein in its entirety.

As used herein, the term “adhesive bonding” means a bonding process which forms a bond by application of an adhesive. Such application of adhesive may be by various processes such as slot coating, spray coating and other topical applications. Further, such adhesive may be applied within a product component and then exposed to pressure such that contact of a second product component with the adhesive containing product component forms an adhesive bond between the two components.

As used herein and in the claims, the term “comprising” is inclusive or open-ended and does not exclude additional unrecited elements, compositional components, or method steps. Accordingly, such terms are intended to be synonymous with the words “has”, “have”, “having”, “includes”, “including”, and any derivatives of these words.

As used herein the terms “recover”, “recovery” and “recovered” shall be used interchangeably and shall refer to a contraction of a stretched material upon termination of a stretching force following stretching of the material by application of the stretching force. For example, if a material having a relaxed, unstretched length of 1 inch (2.5 cm) is elongated fifty percent by stretching to a length of 1.5 inches (3.75 cm), the material would be elongated 50 percent and would have a stretched length that is 150 percent of its relaxed length or stretched 1 .5×. If this exemplary stretched material contracted, that is recovered to a length of 1.1 inches (2.75 cm) after release of the stretching force, the material would have recovered 80 percent of its 0.5 inch (1.25 cm) elongation. Percent recovery may be expressed as [(maximum stretch length-final sample length)/(maximum stretch length—initial sample length)]×100.

As used herein the term “extensible” means elongatable in at least one direction, but not necessarily recoverable.

As used herein the term “percent stretch” refers to the ratio determined by measuring the increase in the stretched dimension and dividing that value by the original dimension. i.e. (increase in stretched dimension/original dimension) ×100.

As used herein the term “set” refers to retained elongation in a material sample following the elongation and recovery, i.e. after the material has been stretched and allowed to relax during a cycle test.

As used herein the term “percent set” is the measure of the amount of the material stretched from its original length after being cycled (the immediate deformation following the cycle test). The percent set is where the retraction curve of a cycle crosses the elongation axis. The remaining strain after the removal of the applied stress is measured as the percent set.

The “load loss” value is determined by first elongating a sample to a defined elongation in a particular direction (such as the CD) of a given percentage (such as 70 or 100 percent as indicated) and then allowing the sample to retract to an amount where the amount of resistance is zero. The cycle is repeated a second time and the load loss is calculated at a given elongation, such as at the 50 percent elongation. Unless otherwise indicated, the value was read at the 50% elongation level (on a 70 percent elongation test) and then used in the calculation. For the purposes of this application, the load loss was calculated as follows:
cycle 1 extension tension (at 50% elongation)—cycle 2 retraction tension (at 50% elongation)×100 cycle 1 extension tension (at 50% elongation)

For the test results reflected in this application, the defined elongation was 70 percent unless otherwise noted. The actual test method for determining load loss values is described below.

As used herein, a “filler” is meant to include particulates and/or other forms of materials which can be added to a film polymer extrusion material which will not chemically interfere with or adversely affect the extruded film and further which are capable of being dispersed throughout the film. Generally the fillers will be in particulate form with average particle sizes in the range of about 0.1 to about 10 microns, desirably from about 0.1 to about 4 microns. As used herein, the term “particle size” describes the largest dimension or length of the filler particle.

As used herein the terms semi-crystalline, predominantly linear polymer and semi-crystalline polymer shall refer to polyethylene, polypropylene, blends of such polymers and copolymers of such polymers. For such polyethylene-based polymers, such term shall be defined to mean polymers having a melt index of greater than about 5 g/10 min, but desirably greater than 10 g/10 min (Condition E at 190° C., 2.16 kg) and a density of greater than about 0.910 g/cc, but desirably greater than about 0.915 g/cc. In one embodiment, the density is between about 0.915 g/cc and 0.960 g/cc. In a further alternative embodiment, the density is about 0.917 g/cc. In a further alternative embodiment, the density is between about 0.917 g/cc and 0.960 g/cc. In still a further alternative embodiment, the density is between about 0.917 g/cc and 0.923 g/cc. In still a further alternative embodiment, the density is between about 0.923 g/cc and 0.960 g/cc. For such polypropylene based polymers, such term shall be defined to mean polymers having a melt flow rate greater than about 10 g/10 min, but desirably greater than about 20 g/10 min. (230° C., 2.16 kg) and having a density between about 0.89 g/cc and 0.90 g/cc.

As used herein, the term “antiblock agent” shall mean a substance, such as for example finely divided solid of a mineral nature, which is added to a polymer mix to prevent adhesion of the surfaces of films made from the polymer to each other or to other surfaces.

Unless otherwise indicated, percentages of components in formulations are by weight.

### Test Method Procedures

Water Vapor Transmission Rate (WVTR)/Breathability:

A suitable technique for determining the WVTR (water vapor transmission rate) value of a film or laminate material of the invention is the test procedure standardized by INDA (Association of the Nonwoven Fabrics Industry), number IST-70.4-99, entitled “STANDARD TEST METHOD FOR WATER VAPOR TRANSMISSION RATE THROUGH NONWOVEN AND PLASTIC FILM USING A GUARD FILM AND VAPOR PRESSURE SENSOR” which is incorporated by reference herein. The INDA procedure provides for the determination of WVTR, the permeance of the film to water vapor and, for homogeneous materials, water vapor permeability coefficient.

The INDA test method is well known and will not be set forth in detail herein. However, the test procedure is summarized as follows. A dry chamber is separated from a wet chamber of known temperature and humidity by a permanent guard film and the sample material to be tested. The purpose of the guard film is to define a definite air gap and to quiet or still the air in the air gap while the air gap is characterized. The dry chamber, guard film, and the wet chamber make up a diffusion cell in which the test film is sealed. The sample holder is known as the Permatran-W Model 100K manufactured by Mocon, Inc., Minneapolis, Minn. A first test is made of the WVTR of the guard film and the air gap between an evaporator assembly that generates 100% relative humidity. Water vapor diffuses through the air gap and the guard film and then mixes with a dry gas flow which is proportional to water vapor concentration. The electrical signal is routed to a computer for processing. The computer calculates the transmission rate of the air gap and the guard film and stores the value for further use.

The transmission rate of the guard film and air gap is stored in the computer as CalC. The sample material is then sealed in the test cell. Again, water vapor diffuses through the air gap to the guard film and the test material and then mixes with a dry gas flow that sweeps the test material. Also, again, this mixture is carried to the vapor sensor. This information is used to calculate the transmission rate at which moisture is transmitted through the test material according to the equation:
TR⁻¹_{test material}=TR⁻¹_{test material, guardfilm, airgap}−TR⁻¹_{guardfilm, airgap}
Calculations:
WVTR: The calculation of the WVTR uses the formula:
   WVTR=Fpₛₐₜ(T)RH/(APₛₐₜ(T)(1−RH))
   where:
F=The flow of water vapor in cc/min.,
pₛₐₜ(T)=The density of water in saturated air at temperature T,
RH=The relative humidity at specified locations in the cell,
A=The cross sectional area of the cell, and,
Pₛₐₜ(T)=The saturation vapor pressure of water vapor at temperature T.

For the purposes of this Application, the testing temperature for the above test was at about 37.8° C., the flow was at 100 cc/min, and the relative humidity was at 60%. Additionally, the value for n was equal to 6 and the number of cycles was 3.

Cycle Testing:

The materials were tested using a cyclical testing procedure to determine load loss and percent set. In particular, 2 cycle testing was utilized to 70 percent defined elongation. For this test, the sample size was 3 inch in the MD by 6 inch in the CD. The Grip size was 3 inch width. The grip separation was 4 inch. The samples were loaded such that the cross-direction of the sample was in the vertical direction. A preload of approximately 10-15 grams was set. The test pulled the sample at 20 inches/min (500 mm/min) to 70 percent elongation (2.8 inches in addition to the 4 inch gap), and then immediately (without pause) returned to the zero point (the 4 inch gauge separation). The results of the test data are all from the first and second cycles. The testing was done on a Sintech Corp. constant rate of extension tester 2/S with a Renew MTS mongoose box (controller) using TESTWORKS 4.07b software (Sintech Corp, of Cary, N.C.). The tests were conducted under ambient conditions.

Melt Index or Melt Flow rate

Melt Index (MI) or Melt Flow Rate (MFR), depending on the polymer being tested, is a measure of how easily a resin flows at a given temperature and shear rate, and can be determined using ASTM Standard D1238, condition 190° C./2.16 kg (Condition E) generally for polyethylene-based or other polymers. The melt index test data in this application were produced in accordance with this method and condition. In general, a polymer having a high melt index has a lower viscosity. For polypropylene-based and other polymers, a similar analysis is conducted for melt flow rate at a condition of 230° C. and 2.16 kg. In accordance with the present invention the combination of melt index or melt flow rate (depending on polymer) and density parameters of the carrier resin results in the improved two phase film with increased ability for the carrier resin to aid in processing and to retain pore formation following stretching. In particular, it has been determined that non-elastic, more crystalline carrier resins with higher MI values (above about 5 g/10 min) and density values (between about 0.910 g/cc and 0.960 g/cc for polyethylene-based polymers) were particularly effective at producing the cores of multilayered breathable films without sacrificing elastic performance. In particular, carrier resins with densities greater than about 0.915 g/cc are desirable. Such carrier resins with densities of about 0.917 g/cc are also desirable. Such carrier resins with densities greater than about 0.917 g/cc are also desirable. In still a further embodiment, such carrier resins with densities between 0.917 g/cc and 0.960 g/cc are desirable. In still a further alternative embodiment, such carrier resins with densities between about 0.917 g/cc and 0.923 g/cc are also desirable. In still a further alternative embodiment, such carrier resins with densities between about 0.923 g/cc and 0.960 g/cc are also desirable. In an alternative embodiment, polypropylene-based carrier resins with lower densities such as about 0.89 g/cc, would also be useful, especially those with a MFR of greater than about 10 g/10 min, but desirably 20g/10 min MFR or greater (conditions 230° C., 2.16 kg). In still a further alternative embodiment, such polypropylene-based carrier resins with densities between about 0.89 g/cc and 0.90 g/cc can also be utilized. It is also desirable to blend such carrier resins separately with a filler, prior to blending the carrier/filler mixture with the elastomer component of the core layer, so that all materials are not compounded together in a single step. It is desirable that the filler be maintained in close association with the carrier in the core rather than blending any filler directly with the elastomer component, such that the carrier resin forms filler rich pockets within the elastomer component of the core layer of a multilayered film.

For the purposes of this application, the term “low viscosity polymer” shall mean a polymer (either neat resin or compounded resin) having an MI at 190° C. of from about 4 (4 g/10 min) to 50, or from 10 MFR (10 g/10 min) up to 100 MFR at 230° C. In an alternative embodiment, such low viscosity polymers have an MI at 190° C. of between 6 to 25, or between 20 to 50 in MFR.

For the purposes of this application, the term “high viscosity polymer” shall mean polymers (such as for example elastomers) having a MI less than 1 MI up to 25 MI for 190° C. or MFR of less than 1 up to 50 MFR at 230° C. In an alternative, such MI is less than 1 up to 10 for 190° C. In a further alternative embodiment, the MI is less than 1 up to 4 for 190° C.

### DETAILED DESCRIPTION

The present invention intends to overcome the above problems of processing breathable elastic films that base their breathability on pores created by filler particles. The problems are addressed in a first embodiment of the invention by a multiple layered filled film wherein the film core composition provides breathability and elasticity without pore collapse, and the skin layers have been designed to produce ease of processing and reduced roll-blocking capability. For the purposes of this application, the term “reduced roll-blocking capability” shall refer to the ability of the material to resist sticking to itself upon being rolled on a storage roll.

The problems are addressed in a second embodiment of the invention by a multilayered breathable elastic film (of at least five layers) which includes at least two skin layers, two outer core layers positioned immediately subjacent the two skin layers and an inner core layer sandwiched by the outer core layers, which outer core layers are designed to enhance processability of such films. Further advantages, features, aspects and details of the invention are evident from the claims, the description and the accompanying drawings.

The multilayered extruded elastic films of the current invention are desirably made from either a cast or blown film process, or extrusion coating type of manufacturing process. While such elastic films, with high content of elastomeric polymer are traditionally difficult to extrude, especially at higher speeds, it has been found that a multilayered film having at least one skin layer with low viscosity polymers, and desirably at least two skin layers with low viscosity polymers and each occupying from about 1 to 25 percent of the film volume is desirable in a first embodiment (alternatively 2 to 25 percent each). It is in one embodiment desirable to have one skin layer on each side of a core layer (as sandwiching the core). In one embodiment, the one or more skin layer is desirably made from a filler such as calcium carbonate and the low viscosity polymer. It has been found that a film with such low viscosity skin layers is easier to process at higher speeds, and also provides a web stabilizing layer for attachment to a nonwoven web (should a laminate of the film and a nonwoven layer be desirable). In another embodiment, the skin layer as described is a fully compounded formulation.

Such low viscosity polymers may be styrenic block copolymers, such as for example SEBS and SEB polymers available from KRATON Polymers. Examples of such block copolymers include SEB polymers, such as KRATON® G 1657 (25 MFR at 230° C., 2.16 kg) and SEBS polymers, such as “KRATON DHV” (4MI at 190° C., 2.16 kg), which has a vinyl content of the polydiene block prior to hydrogenation of 60 to 85 mol percent. Other such block copolymers are available from Septon Company of America, Dexco Polymers, and Dynasol. Still other low viscosity polymers include single site catalyzed polyolefinic plastomers, such as those available from The Dow Chemical Company under the AFFINITY name (Dow AFFINITY PL 1280 LDPE (6 MI at 190° C., 2.16 kg)) or under the EXACT name from ExxonMobil. Such single site catalyzed materials include metallocene catalyzed materials and constrained geometry polymers.

The core layer is desirably formed with a high viscosity polymer. Such high viscosity polymers are available from KRATON Polymers as styrenic block copolymers, examples of which include KRATON® G 1730 tetrablock (27 MI at 230° C.) and “KRATON DCP” (SEBS with less than 1 MI at 190° C., 13 MFR at 250° C., 5 kg). Examples of other high viscosity polymers (elastomers or plastomers) include Septon 2004 (MFR of 5 at 230° C., 2.16 kg, 27 MFR at 250° C., 5 kg) from Septon Company of America and Dow AFFINITY polymers. The core in one embodiment, may include two elastomers (or elastomer and plastomer), with one being of a high viscosity polymer, the other being of a low or lower viscosity polymer. In such an embodiment, the high viscosity polymer weight percentage desirably exceeds the low viscosity polymer weight percentage.

The layer ratio of the skin(s) to the core can be varied to selectively change the elasticity and breathability attributes. This type of structure could, for example be used to produce a film with lower or no appreciable breathability, by changing the ratio of the filler concentrate. Such a multilayered film can be made with a BAB type structure, where the core layer “A” ranges from 50 to 98 percent of the film volume, desirably 50 to 96 percent of the film volume, and the skin or outer layers “B” range from a total of 2 to 50 volume percent, desirably 4 to 50 percent. It should be appreciated that the skin layer numbers are for both skin layers, such that each of the skin layers would be half of the total, such as between about 1 and 25 percent of the film volume (or alternatively 2 and 25). The core layer can be comprised of a high viscosity polymer (elastomer) component as the primary elastomer component, or alternatively, may comprise a high viscosity polymer (elastomer) component blended with a lower viscosity polymer (elastomer) component as previously stated.

Desirably, if the core layer includes two elastomer components, it is desirable that the higher viscosity polymer component be present in a ratio of between about 3:1 to 4:1 with the low (or lower) viscosity polymer component. In an alternative embodiment, such skin layers include a low viscosity polymer and a filled polymer compound of another resin distinct from the low viscosity polymer. In such an instance, such filler is desirably calcium carbonate and is present in an amount of between about 50 and 80 percent and the carrier resin in the compound is present in an amount of between about 20 and 50 percent. These percentages are by weight. Desirably the compound is present in an amount with the low viscosity polymer between about 50 and 75 percent. Such compounded resin may for example be a polyethylene, desirably a LLDPE such as for example DOWLEX™ 2517 LLDPE.

It is desirable in another embodiment, for the difference in MI between the low viscosity polymer and the high viscosity polymer to be at least about 5 MI (or 12 MFR) and desirably at least about 10 MI (or 22 MFR) or alternatively, that the difference be at least about 15 MI (or 30 MFR).

In still another alternative embodiment, at least a five layer film may be produced that has a CABAC type structure. In such a structure, the “B” layer would serve as an inner core layer and could range from about 40 to 85 percent of the film volume structure (alternatively 50 to 85 volume percent). The inner core layer provides the high viscosity polymer (elastomer) component. Such high viscosity polymer component may include a single elastomer component or a blend of a high viscosity polymer component and a lower viscosity polymer component (as in the previous three layered embodiment). If the inner core layer is a blend, it is desirable that the high viscosity polymer component be in a ratio of between about 3:1 to 4:1, with the lower viscosity polymer component. The “A” components serve as the outer core components and each range in one embodiment from about 6 to 25 percent of the total film volume (total outer core volume of 12 to 50). In an alternative, each of the outer core components ranges from about 12 to 25 percent of the volume. In still another alternative embodiment, the total outer core volume ranges from 40 to 50 volume percent. The “A” component provides a low viscosity elastomer component to aid in processing through the film die. The “C” components serve as the skin layer(s) and desirably is/are present in about 2-4 percent of the film volume (1-2 percent for each skin layer).

It should be recognized that each of the various layers described above with respect to the three and five layer embodiments may also include other materials. For example, in order to achieve breathability in an elastic core layer, it has been necessary to include other components such as filler and carrier polymers for carrying the filler. Such layers may also include processing aids, stabilizers, antioxidants and coloring agents as well. The skin layer(s) may also include one or more anti-blocking components to reduce roll blocking.

In one embodiment, the skin layer is a low density polyethylene or filled low density polyethylene, that prevents or reduces roll-blocking and also improves die life by reducing or eliminating die build-up. The skin layer can also improve the annealing of the elastomeric resin based film structure at higher temperatures, without sticking to the rolls of a machine direction orienter (as will be described below). As a result, such structure can improve the dimensional stability of the stretchable and breathable film. In another alternative embodiment, the skin layers are comprised of filled polypropylene, or polypropylene copolymers.

It has been found that each of the above multilayered film structures allow for improved processing and reduced roll-blocking functionality. In contrast, it has been found that low viscosity elastomers do not have enough mechanical strength in and of themselves, for stretching in a machine direction orienter (to impart breathability) and demonstrate reduced hysteresis or stress relaxation properties, when present by themselves. While blends of low and high viscosity polymers in single layer films have given slight improvements in processability, they have also demonstrated reduction in mechanical properties/processing ability when used as a single layer structure.

By creating separate functional layers of primarily low viscosity skins or outer layers, with some elastic performance and low modulus, over a core of primarily high viscosity elastomer, with carrier resin and filler, a film is produced which provides enhanced processing and mechanical properties. Each of these core and skin/outer layers may also include fillers to create or improve breathability.

For example, in the BAB film construction, the “B” layer can be comprised of 30 percent of a low viscosity elastomer such as “KRATON DHV”, 50 percent of a filler such as calcium carbonate and 20 percent of a polyethylene, such as DOWLEX™ LLDPE 2517. The “A” core layer can contain 33 percent of a higher viscosity elastomer, such as KRATON® G 1730 with 67 percent of a compound of filler and carrier polymer (polyethelene), such as 75 percent calcium carbonate and 25 percent DOWLEX™ 2517. These layers can be extruded at a ratio of about 12 to 20 percent of the combined “B” layers with about 80-88 percent of the core “A” layer.

Two methods of formulating films for making breathable filled films are a concentrate letdown approach and a fully compounded approach. For the purposes of at least the breathable films of the current application, the concentrate letdown approach is desirable. In the concentrate letdown process, one resin is used as a carrier resin to make a concentrate with a filler. In one embodiment of the invention, the carrier resin, typically a high melt index or melt flow rate/low viscosity resin with higher density level for polyethylene-based polymers (0.910 g/cc-0.960 g/cc), and a density level between about 0.89 g/cc and 0.90 g/cc for polypropylene-based polymers, is used to disperse high loadings of filler. The high viscosity elastic letdown resin dominates the elastic properties of the core layer of the multilayered film. The concentrate is let down (combined) with elastic resin(s) to dilute the final filler content to a desired percentage in the core layer of the multilayered film.

Therefore in one embodiment, the core (or inner core in the case of a five layered film) of the elastic, breathable film is made from at least a high viscosity elastomer let down resin, desirably a block copolymer (such as a styrenic block copolymer) that has been blended with a semi-crystalline, predominantly linear polymer (carrier resin) which includes a filler (the “concentrate”). Alternatively, such high viscosity elastomer is blended with a lower viscosity elastomer. Desirably, the elastic polymer(s) is/are blended with a single screw extruder so as to avoid/reduce substantial mixing of the polymer phases, and retain pockets of the carrier resin within the letdown resin(s) (in the core layer). The filler, such as calcium carbonate, may create filled regions within the extruded film core layer, which can be stretched to form pores at a polymer/filler interface without negatively impacting the elastic recovery of the elastic polymer component. Without intending to be limited by theory, it is believed that the pores in the filled regions do not collapse as the formed pores are surrounded by an inelastic semi-crystalline polymer. As was stated previously, either higher density polyethylene-based carrier resins or polypropylene-based carrier resins with densities between 0.89 g/cc and 0.90 g/cc are preferred. Desirably, the filled carrier semi-crystalline polymer (filled polymer or concentrate) is compounded with the filler prior to combining with the thermoplastic elastomer let down resin(s) to associate the filler particle with the semi crystalline polymer and thereby inhibit the collapse of any pores formed upon stretching the film.

One or more skin or outer layers can be coextruded with the core layer(s) to provide a multilayered elastic and breathable film. In one embodiment of the elastic breathable film, one or more skin layers includes a low density polyethylene and a filler. In one embodiment, the filler is calcium carbonate. In another embodiment, the one or more skin layers includes a low density polyethylene and an additional nonblocking agent. Desirably, such skin or outer layers are comprised of low density polyethylenes having densities between about 0.915 and 0.923 g/cc. Examples of such polymers include ExxonMobil LD 202 and LD 202.48.

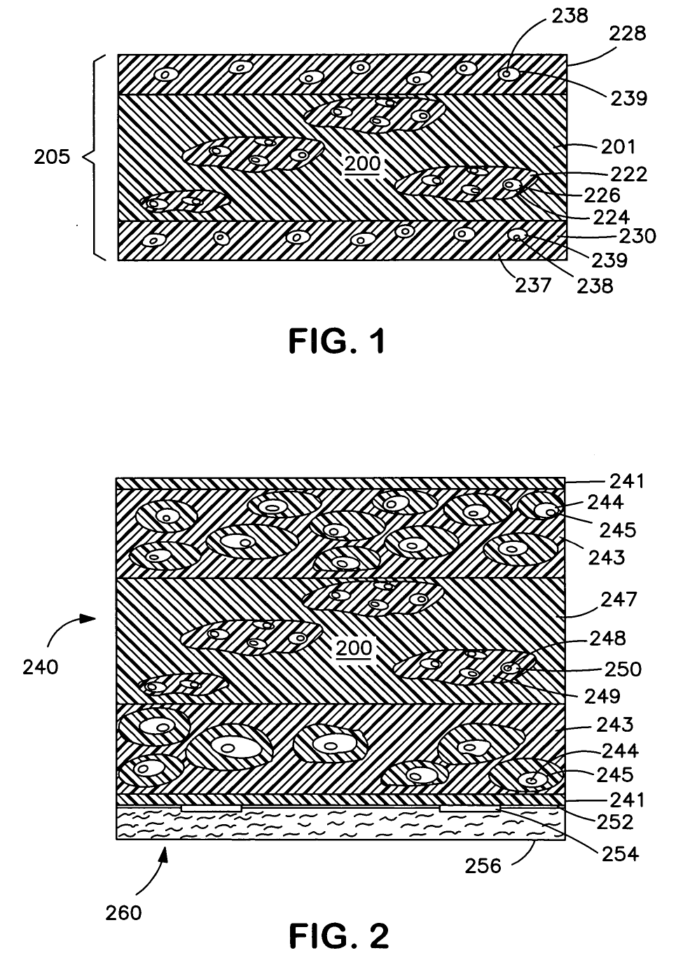

Referring to FIG. 1, a cross sectional view of one embodiment of the multilayered film (product film that has been stretched) made in accordance with the invention is shown. In this particular embodiment, the film 205 includes an elastomeric core layer 201 having an elastomeric component 200. Skin (or outer) layers 228 and 230 are positioned on each opposing surface of the film core layer 201. While two skin layers are illustrated in FIG. 1 on opposing sides of the core layer, it should be appreciated that the film may include only one skin layer, such as skin layer 228, or more than one skin layers, such that more than one skin layer is present on at least one surface of the core layer 201.

In the core layer 201, semi-crystalline polymer/filler rich pockets 222 are dispersed throughout the high viscosity elastomeric component 200, desirably with the filler isolated or closely associated with the carrier resin locations. It should be recognized that the elastomeric component can include high viscosity and lower viscosity elastomeric components as previously described. Filler particles 224 are contained within the semi-crystalline polymer pockets 222 or pores. The pores are created by the hard shell/walls of the semi-crystalline polymer phase within the elastomeric polymer phase. The pores/spaces 226 are formed between the semi-crystalline polymers and the filler particles 224 as the film is stretched in a machine direction orienter or other stretching device. Since the shells are made of a semi-crystalline material, they retain much of their shape, albeit in a compressed or elongated oval-type shape when stretched uniaxially, rather than a perfectly circular configuration. The shells retain a more circular configuration when stretched biaxially.

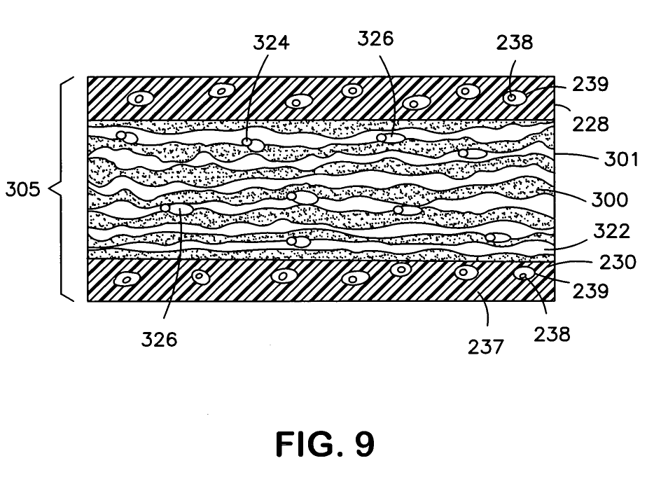

It should be recognized that FIG. 1 is a stylized schematic image, and that numerous other polymer morphologies and/or embodiments are contemplated by the present invention. For example, the core layer may achieve a stream-like, co-continuous polymer morphology through selective control over the viscosity of the polymers, the blending parameters, etc. Referring to FIG. 9, for instance, one embodiment of a film 305 is shown that includes semi-crystalline polymer and high viscosity elastomeric phases 322 and 300, respectively, which alternate within a core layer 301 in a relatively co-continuous, stream-like configuration. Filler particles 324 are embedded within the core layer 301 so that they are isolated or closely associated with the locations of the semi-crystalline polymer phase 322. Upon stretching the film 305, pores/spaces 326 are formed between the filler particles 324 and the semi-crystalline and/or high viscosity elastomeric polymers.

Various high viscosity thermoplastic elastomers are contemplated for use in this invention as the core elastomeric portion. However, thermoplastic block polymers such as styrenic block copolymers are examples of useful elastic polymers of the invention. Specific examples of useful styrenic block copolymers include hydrogenated polyisoprene polymers such as styrene-ethylenepropylene-styrene (SEPS), styrene-ethylenepropylene-styrene-ethylenepropylene (SEPSEP), hydrogenated polybutadiene polymers such as styrene-ethylenebutylene-styrene (SEBS), styrene-ethylenebutylene-styrene-ethylenebutylene (SEBSEB), styrene-butadiene-styrene (SBS), styrene-isoprene-styrene (SIS), and hydrogenated poly-isoprene/butadiene polymer such as styrene-ethylene-ethylenepropylene-styrene (SEEPS). Polymer block configurations such as diblock, triblock, multiblock, star and radial are also contemplated in this invention. In some instances, higher molecular weight block copolymers may be desirable. Block copolymers are available from KRATON Polymers U.S. LLC of Houston, Tex. under the designations KRATON® G polymers and Septon Company of America, Pasadena, Tex. Another potential supplier of such polymers includes Dynasol of Spain, and Dexco polymers of Houston, Tex. Blends of such polymers are contemplated for the core layer(s), providing that the high viscosity component is present in an amount of between about 3:1 and 4:1 to that of a lesser viscosity component. In an alternative embodiment, such high viscosity component should be present in an amount of at least 3 times the amount of a lesser viscosity component in a blend. For example, in one embodiment, the high viscosity component can be “KRATON DCP” and the lesser viscosity component can be KRATON® G 1657, with the higher viscosity component present in an amount of about 25-30 percent of the core, and the lesser viscosity component present in an amount of between about 6 and 10 percent by weight of the core. The remaining weight percentage of the core layer would desirably be filler and a filler carrier resin.

In one embodiment, it is desirable that the high viscosity styrenic block copolymer be a SEPS polymer. The thermoplastic elastomers themselves may include processing aids and/or tackifiers associated with the elastomeric polymers.

Other thermoplastic elastomers useful in the invention include olefinic-based elastomers such as EP rubber, ethyl, propyl, butyl terpolymers, block and copolymers thereof. Desirably, the film core layer of the filler, carrier resin and elastomeric letdown resin materials includes between about 15 and 50 weight percent high viscosity elastomeric polymer component (one or more polymers). It should be recognized, that when the elastomer component of the blended elastomeric composition is given, it may include neat base resins along with processing aids such as low molecular weight hydrocarbon materials such as waxes, amorphous polyolefins and/or tackifiers.

Both organic and inorganic fillers are contemplated for use with the present invention, provided they do not interfere with the film forming process and/or subsequent laminating processes. Examples of fillers include calcium carbonate (CaCO₃), various clays, silica (SiO₂), alumina, barium sulfate, sodium carbonate, talc, magnesium sulfate, titanium dioxide, zeolites, aluminum sulfate, cellulose-type powders, diatomaceous earth, gypsum, magnesium sulfate, magnesium carbonate, barium carbonate, kaolin, mica, carbon, calcium oxide, magnesium oxide, aluminum hydroxide, pulp powder, wood powder, cellulose derivatives, polymeric particles, chitin and chitin derivatives.

The filler particles may optionally be coated with a fatty acid, such as stearic acid or behenic acid, and/or other material in order to facilitate the free flow of the particles (in bulk) and their ease of dispersion into the carrier polymer. One such filler is calcium carbonate sold under the brand SUPERCOAT, of Imerys of Roswell, Ga. Another is OMYACARB 2 SS T of Omya, Inc. North America of Proctor, Vt. The latter filler is coated with stearic acid. Desirably, the amount of filler in the product film core layer (final film formulation) is between about 40 and 70 weight percent. More desirably, the amount of filler in the product film core layer is between about 45 and 60 weight percent.

Examples of semi-crystalline carrier polymers useful in compounding with filler include, but are not limited to predominantly linear polyolefins (such as polypropylene and polyethylene) and copolymers thereof. Such carrier materials are available from numerous sources. Specific examples of such semi-crystalline polymers include ExxonMobil 3155, Dow polyethylenes such as DOWLEX™ 2517 (25 MI, 0.917 g/cc); Dow LLDPE DNDA-1082 (155 MI, 0.933 g/cc), Dow LLDPE DNDB-1077 (100 MI, 0.929 g/cc), Dow LLDPE 1081 (125 MI, 0.931 g/cc), and Dow LLDPE DNDA 7147 (50 MI, 0.926 g/cc). In some instances, higher density polymers may be useful, such as Dow HDPE DMDA-8980 (80 MI, 0.952 g/cc).

Additional resins include Escorene LL 5100, having a MI of 20 and a density of 0.925 and Escorene LL 6201, having a MI of 50 and a density of 0.926 from ExxonMobil.

In an alternative embodiment, polypropylene carrier resins with lower densities such as at about 0.89 g/cc, would also be useful, especially those with a 10 g/10 min MFR, but desirably a 20 MFR or greater (conditions of 230° C., 2.16 kg). Polypropylene-based resins having a density of between 0.89 g/cc and 0.90 g/cc would be useful, such as homopolymers and random copolymers such as ExxonMobil PP3155 (36 MFR), PP1074KN (20 MFR), PP9074MED (24 MFR) and Dow 6D43 (35 MFR).

It is desirable that the melt index of the semi-crystalline polymer (for polyethylene-based polymers) be greater than about 5 g/10 min, as measured by ASTM D1238 (2.16kg, 190° C). More desirably, the melt index of the semi-crystalline polymer is greater than about 10 g/10 min. Even more desirably, the melt index is greater than about 20g/10 min. Desirably, the semi-crystalline carrier polymer has a density of greater than about 0.910 g/cc, but even more desirably greater than about 0.915 g/cc for polyethylene-based polymers. Even more desirably, the density is about 0.917 g/cc. In another alternative embodiment, the density is greater than 0.917 g/cc. In still another alternative embodiment, the density is between about 0.917 g/cc and 0.923 g/cc. In still another alternative embodiment, the semi-crystalline carrier polymer has a density between about 0.917and 0.960 g/cc. In yet another alternative embodiment, the semi-crystalline polymer has a density between about 0.923 g/cc and 0.960 g/cc. It is also desirable that the film core layer contains between about 10 and 25 weight percent semi-crystalline polymer.

In addition, the breathable filled film layer(s) may optionally include one or more stabilizers or processing aids. For instance, the filled-film may include an anti-oxidant such as, for example, a hindered phenol stabilizer. Commercially available anti-oxidants include, but are not limited to, IRGANOX E 17 (a-tocopherol) and IRGANOX 1076 (octodecyl 3,5-di-tert-butyl-4-hydroxyhydrocinnamate) which are available from Ciba Specialty Chemicals of Tarrytown, N.Y. In addition, other stabilizers or additives which are compatible with the film forming process, stretching and any subsequent lamination steps, may also be employed with the present invention. For example, additional additives may be added to impart desired characteristics to the film such as, for example, melt stabilizers, processing stabilizers, heat stabilizers, light stabilizers, heat aging stabilizers and other additives known to those skilled in the art. Generally, phosphite stabilizers (i.e. IRGAFOS 168 available from Ciba Specialty Chemicals of Tarrytown, N.Y. and DOVERPHOS available from Dover Chemical Corp. of Dover, Ohio) are good melt stabilizers whereas hindered amine stabilizers (i.e. CHIMASSORB 944 and 119 available from Ciba Specialty Chemicals of Tarrytown, N.Y.) are good heat and light stabilizers. Packages of one or more of the above stabilizers are commercially available such as B900 available from Ciba Specialty Chemicals. Desirably about 100 to 2000 ppm of the stabilizers are added to the base polymer(s) prior to extrusion (Parts per million is in reference to the entire weight of the filled-film).

Desirably in one embodiment, a concentrate of “filled polymer” (carrier resin and filler) is made for the core layer(s), with the filler and the semi-crystalline carrier polyolefin in the range of between about 60-85 percent by weight filler, but more desirably between about 70-85 percent by weight filler. It is also desirable to reduce the amount of the semi-crystalline polymer in the final composition so as to have the least impact on the elastic performance of the elastomeric polymer phase of the core layer(s). The high viscosity elastic polymer (or polymer blend) is blended with the filled polymer concentrate resin prior to introduction into the film screw extruder in a blending station as a “letdown” resin. The concentration of the block polymer is then generally determined by the desired filler level in the final composition. The level of filler will affect breathability as well as elastic properties of the film core layer(s) and ultimate multiple layered film. In one embodiment, it is desirable for the filler to be present in the filled polymer in an amount of greater than 80 weight percent, such that the film demonstrates the desired properties which are described below.

As an example, the filler may be present in a film core layer(s) of between about 25-65 weight percent, the high viscosity elastomer (or blend) may be present in a range between about 15-60 weight percent, and the semi-crystalline polymer may be present in a range of between about 5-30 weight percent.

The skin layers 228 and 230 of the multilayered film are desirably formed from a coextrusion process with the core layer, and processed along with the core layer in the stretching and other post formation processes. In FIGS. 1 and 9, for instance, two filled skin layers are illustrated. The skin layers are illustrated to include filler particles 238 in addition to the skin layer polymer 237. After the film is stretched, spaces form around the skin layer particles 238 to form pores 239.

The skin layer(s) of such a multilayered breathable and elastic film desirably do not hinder the elastic and breathable attributes of the core layer. Such skin layers desirably also provide additional functionality to the core layer features. For example, in one embodiment, it is desirable that skin layer(s) provide nonblocking functionality only.

In an alternative embodiment, such skin layer includes filler, such as calcium carbonate, along with a polyethylene base resin in order to enhance the printability attributes of such multilayered film, reduce the blocking of such film even further, and also to provide enhanced bonding capability of such film to other sheet materials with the use of adhesives. If such filler is present, it is desirably present in an amount of between about 10 and 50 weight percent of the skin layer(s).

In an alternative embodiment of the multilayered breathable elastic film, as illustrated in FIG. 2, a five layer film includes two skin or outer layers 241. For the purposes of the illustration, such skin layers are shown as monolayers. It should be understood that alternatively, such skin layers may also include filler or other processing aids as well. Beneath the skin layers 241, an outer core layer 243 is illustrated. Such outer core layer is desirably comprised of primarily a lower viscosity elastomer or elastomer blend. Such outer core layers 243 also include filler particles 244 and carrier resins 245 in order to create pore structures. An inner core layer 247 is sandwiched between the outer core layers 243 and includes a high viscosity elastomer 200 or elastomer blend, and filler particles 248 contained in carrier resin 249. Pores 250 are formed around the filler particles.

In an alternative embodiment of the invention, each of the film embodiments described above can be laminated to one or more additional sheet material layers as part of a multi-layered laminate. For instance, as seen in FIG. 2, the five layered film 240 can be laminated to one or more nonwoven or woven webs or scrims 256. In one embodiment, the film can be laminated to a spunbond web. Such spunbond web can be of a single component, or alternatively of a bicomponent/conjugate arrangement. Desirably, such spunbond web has a basis weight of between about 10 and 50 gsm. Alternatively, such film can be laminated to a coform, meltblown, or bonded carded web.

The film may be laminated to additional sheet materials by adhesive 252, thermal calendaring, extrusion coating or ultrasonic bonding methods. In some instances, the layer that is laminated to the film may provide support to the film, and may be fairly characterized as a support layer. In other instances such additional layer may provide other types of functionality, such as an improved hand. Such film/nonwoven laminates may be particularly effective as components of personal care products, such as elastic ears (as described below). As is illustrated in FIG. 2, such multi-layered film may include a printed image 254 which can be seen through the nonwoven layer 256 from direction 260. Such a construction may for example serve as an outercover of a personal care product/article, where the film layer is facing the skin of the user of such a product and the nonwoven layer is facing away from the skin of the user. In an alternative embodiment, the film may be sandwiched between two nonwoven facing layers.

Process:

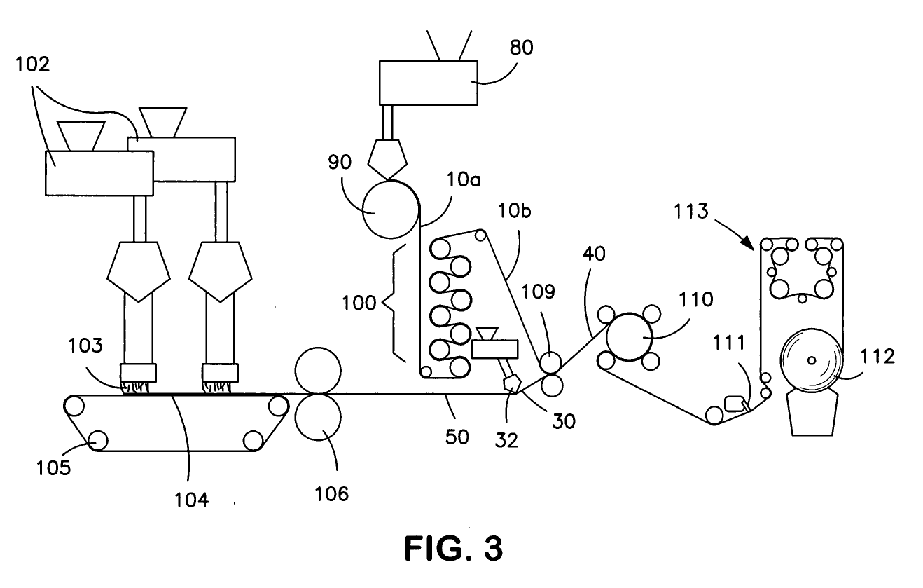

A process for forming the breathable, elastic film 10 is shown in FIG. 3 of the drawings. Before the breathable elastic film is manufactured, the raw materials, i.e. the semi-crystalline carrier polymer(s) and filler must first be compounded such as through the following process. The filler and semi-crystalline polymer raw materials are added into a hopper of a twin screw extruder or high intensity mixer, (both available from Farrel Corporation, of Ansonia Conn.) and are dispersively mixed in the melt, by the action of the intermeshing rotating screws or rotors. The resulting mixture is pelletized and is referred to herein as the filler concentrate or filler concentrate compound. The filler concentrate compound and the elastomer resin are then desirably processed in a film process by means of a single, barrier screw extruder, followed by a melt pump feeding a film die. It should therefore be recognized that the materials are not all fully compounded together in one step, rather it is a separate step process that accomplishes the compounding of the carrier polymer with the filler and then another step which combines the filled carrier resin and the thermoplastic elastomer(s).

Referring again to the Figure, the compounded polymers and filler are placed in an extruder 80 apparatus and then cast or blown into a film. A precursor film 10a is then extruded (at a temperature range of between about 380-440° F.) onto for instance, a casting roll 90, which may be smooth or patterned. The multiple layers are coextruded together onto the casting roll. For example, three extruders would help to extrude three layers side by side through a film die. The term “precursor” film shall be used to refer to the film prior to being made breathable, such as by being run through a machine direction orienter. The flow out of the extruder die is immediately cooled on the casting roll 90. A vacuum box (not shown) may be situated adjacent the casting roll in order to create a vacuum along the surface of the roll to help maintain the precursor film 10a lying close to the surface of the roll. Additionally, air knives or electrostatic pinners (not shown) may assist in forcing the precursor film 10a to the casting roll surface as it moves around the spinning roll. An air knife is a device known in the art which focuses a stream of air at a very high flow rate to the edges of the extruded polymer material. The precursor film 10a (prior to run through the MDO) is desirably between about 20 and 100 microns in thickness, and has an overall basis weight of between about 30 gsm and 100 gsm. In one embodiment the basis weight is between about 50-75 gsm. Following stretching in a stretching apparatus, the basis weight of the film is between about 10 and 60 gsm, but desirably between about 15 and 60 gsm.

As previously stated, the precursor film 10a is subjected to further processing to make it breathable. Therefore, from the extrusion apparatus 80, and casting roll 90, the precursor film 10a is directed to a film stretching unit 100, such as a machine direction orienter or “MDO” which is a commercially available device from vendors such as the Marshall and Williams Company of Providence, R.I. This apparatus may have a plurality of stretching rollers (such as for example from 5 to 8) which progressively stretch and thin the film in the machine direction, which is the direction of travel of the film through the process as shown in FIG. 3. While the MDO is illustrated with eight rolls, it should be understood that the number of rolls may be higher or lower, depending on the level of stretch that is desired and the degrees of stretching between each roll. The film can be stretched in either single or multiple discrete stretching operations. It should be noted that some of the rolls in an MDO apparatus may not be operating at progressively higher speeds.

Desirably, the unstretched filled film 10a (precursor film) will be stretched (oriented) from about 2 to about 5 times its original length, imparting a final stretch of between 1.5 to about 4 times of the original film length after the film is allowed to relax at the winder. In an alternative embodiment, the film may be stretched through intermeshing grooved rolls such as those described in U.S. Pat. No. 4,153,751 to Schwarz.

Referring again to FIG. 3, some of the rolls of the MDO 100 may act as preheat rolls. If present, these first few rolls heat the film above room temperature (125° F.). The progressively faster speeds of adjacent rolls in the MDO act to stretch the filled precursor film 10a. The rate at which the stretch rolls rotate determines the amount of stretch in the film and final film weight. Microvoids are formed during this stretching to render the film microporous and subsequently breathable. After stretching, the stretched film 10b may be allowed to slightly retract and/or be further heated or annealed by one or more heated rolls 113, such as by heated anneal rolls. These rolls are typically heated to about 150-220° F. to anneal the film. The film may then be cooled. After exiting the MDO film stretching unit, the then breathable product film 10 (which includes a core and at least one skin layer) may be wound on a winder for storage or proceed for further processing.

If desired, the produced product film 10 may be attached to one or more layers 50, such as nonwoven layers (for instance, spunbond), to form a multilayer film/laminate 40. Suitable laminate materials include nonwoven fabrics, multi-layered nonwoven fabrics or sheet materials, scrims, woven fabrics and other like materials. In order to achieve a laminate with improved body conformance, the fibrous layer is itself desirably an extensible fabric and even more desirably an elastic fabric. For example, tensioning a nonwoven fabric in the MD causes the fabric to “neck” or narrow in the CD and give the necked fabric CD extensibility.

Examples of additional suitable extensible and/or elastic fabrics include, but are not limited to, those described in U.S. Pat. No. 4,443,513 to Meitner et al.; U.S. Pat. No. 5,116,662 to Morman et al.; U.S. Pat. No. 4,965,122 to Morman et al.; U.S. Pat. No. 5,336,545 to Morman et al.; U.S. Pat. No. 4,720,415 to Vander Wielen et al.; U.S. Pat. No. 4,789,699 to Kieffer et al.; U.S. Pat. No. 5,332,613 to Taylor et al.; U.S. Pat. No. 5,288,791 to Collier et al.; U.S. Pat. No. 4,663,220 to Wisneski et al.; and U.S. Pat. No. 5,540,976 to Shawver et al. The entire content of the aforesaid patents are incorporated herein by reference. Such necked nonwoven material may be bonded to the film of the present invention. In an alternative embodiment, a slit and necked nonwoven material may be bonded to the film of the present invention. In still a further alternative embodiment, a spunbond support layer may be stretched in grooved rolls from between 1.5 to 3× in the CD and then necked to the original width or to match the width of the film prior to being adhesively laminated to the film.

Nonwoven fabrics which may be laminated to such product films 10 desirably have a basis weight between about 10 g/m² and 50 g/m² and even more desirably between about 15 g/m² and 30 g/m². As a particular example, a 17 g/m² (0.5 ounces per square yard) web of polypropylene spunbond fibers can be necked a desired amount and thereafter laminated to a breathable stretched filled-product film 10. The product film 10 would therefore be nipped (in an adhesive nip, or lamination rolls of a calender roll assembly 109) to a necked or CD stretchable spunbond nonwoven web.

The spunbond layer, support layer, or other functional laminate layer may either be provided from a pre-formed roll, or alternatively, be manufactured in-line with the film and brought together shortly after manufacture. For instance, as is illustrated in FIG. 3, one or more spunbond extruders 102 meltspin spunbond fibers 103 onto a forming wire 104 that is part of a continuous belt arrangement. The continuous belt circulates around a series of rollers 105. A vacuum (not shown) may be utilized to maintain the fibers on the forming wire. The fibers may be compressed via compaction rolls 106. Following compaction, the spunbond or other nonwoven material layer is bonded to the product film 10. Such bonding may occur through adhesive bonding, such as through slot or spray adhesive systems, thermal bonding or other bonding means, such as ultrasonic, microwave, extrusion coating and/or compressive force or energy. An adhesive bonding system 32 is illustrated. Such a system may be a spray or a slot coat adhesive system.

Examples of suitable adhesives that may be used in the practice of the invention include Rextac 2730, 2723 available from Huntsman Polymers of Houston, Tex., as well as adhesives available from Bostik Findley, Inc, of Wauwatosa, Wis. In an alternative embodiment, the film and nonwoven support layer are laminated with an adhesive such that the basis weight of the adhesive is between about 1.0 and 3.0 gsm. The type and basis weight of the adhesive used will be determined on the elastic attributes desired in the final laminate and end use. In another alternative embodiment, the adhesive is applied directly to the nonwoven support layer prior to lamination with the film. In order to achieve improved drape, the adhesive may be pattern applied to the outer fibrous layer.

The film and support layer material typically enter the lamination rolls at the same rate as the film exits the MDO if present. Alternatively, the film is tensioned or relaxed as it is laminated to the support layer. In an alternative embodiment, bonding agents or tackifiers may be added to the film to improve adhesion of the layers. As previously stated, the filled-multilayered film and fibrous layer can be adhesively laminated to one another. By applying the adhesive to the outer fibrous layer, such as a nonwoven fabric, the adhesive will generally only overlie the film at fiber contact points and thus provide a laminate with improved drape and/or breathability. Additional bonding aids or tackifiers can also be used in the fibrous or other outer layer.

After bonding, the laminate 40 may be further processed. Following lamination, the multilayered laminate may be subjected to numerous post-stretching manufacturing processes. For instance, such laminate may be slit, necked, apertured or printed. Alternatively, such laminate may be coursed through a series of grooved rolls that have grooves in either the CD or MD direction, or a combination of such. Such processing step 110 may provide additional desired attributes to the laminate 40, such as softness, without sacrificing elasticity or breathability. For instance, the grooved rolls may be constructed of steel or other hard material (such as a hard rubber) and may include between about 4 and 15 grooves per inch. In an alternative embodiment the grooved rolls may include between about 6 and 12 grooves per inch. In still a further alternative embodiment the grooved rolls include between about 8 and 10 grooves per inch. In still a further alternative embodiment grooves on such rolls include valleys of between about 100 thousandths and 25 thousandths of an inch. Following any additional treatment, the laminate may be further slit, 111, annealed 113, and/or wound on a winder 112.

In manufacturing the multilayered films of the present application, it has been found that by avoiding corona treatment of film, and adhering to narrow winding conditions, film performance can be maintained or enhanced. For example, roll blocking can be avoided.

The inventive film and/or film laminate may be incorporated into numerous personal care products. For instance, such materials may be particularly advantageous as a stretchable outer cover for various personal care products. Additionally, such film may be incorporated as a base fabric material in protective garments such as surgical or hospital drapes/gowns. In still a further alternative embodiment, such material may serve as a base fabric for protective recreational covers such as car covers and the like.

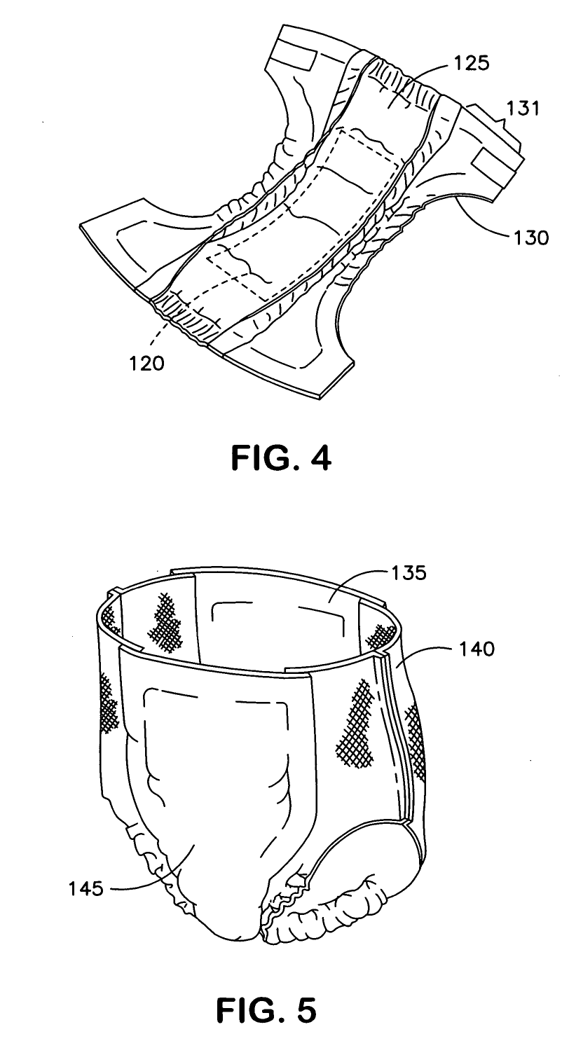

In this regard, FIG. 4 is a perspective view of an absorbent article, such as a disposable diaper of the present invention, in its opened state. The surface of the diaper which contacts the wearer is facing the viewer. With reference to FIG. 4, the disposable diaper generally defines a front waist section, a rear waist section, and an intermediate section which interconnects the front and rear waist sections. The front and rear waist sections include the general portions of the article which are constructed to extend substantially over the wearer's front and rear abdominal regions, respectively, during use. The intermediate section of the article includes the general portion of the article that is constructed to extend through the wearer's crotch region between the legs.

The absorbent article includes an outer cover 130, a liquid permeable bodyside liner 125 positioned in facing relation with the outer cover, and an absorbent body 120, such as an absorbent pad, which is located between the outer cover and the bodyside liner. The outer cover in the illustrated embodiment, coincide with the length and width of the diaper. The absorbent body generally defines a length and width that are less than the length and width of the outer cover, respectively. Thus, marginal portions of the diaper, such as marginal sections of the outer cover, may extend past the terminal edges of the absorbent body. In the illustrated embodiment, for example, the outer cover extends outwardly beyond the terminal marginal edges of the absorbent body to form side margins and end margins of the diaper. The bodyside liner is generally coextensive with the outer cover but may optionally cover an area which is larger or smaller than the area of the outer cover, as desired.

The outer cover and bodyside liner are intended to face the garment and body of the wearer, respectively, while in use. The film or film laminates of the present invention may conveniently serve as the outercover in such an article.

Fastening means, such as hook and loop fasteners, may be employed to secure the diaper on a wearer. Alternatively, other fastening means, such as buttons, pins, snaps, adhesive tape fasteners, cohesives, mushroom-and-loop fasteners, or the like, may be employed.

The diaper may also include a surge management layer located between the bodyside liner and the absorbent body to prevent pooling of the fluid exudates and further improve the distribution of the fluid exudates within the diaper. The diaper may further include a ventilation layer (not illustrated) located between the absorbent body and the outer cover to insulate the outer cover from the absorbent body to reduce the dampness of the garment facing surface of the outer cover.

The various components of the diaper are integrally assembled together employing various types of suitable attachment means, such as adhesive, sonic bonds, thermal bonds or combinations thereof. In the shown embodiment, for example, the bodyside liner and outercover may be assembled to each other and to the absorbent body with lines of adhesive, such as a hotmelt, pressure-sensitive adhesive. Similarly, other diaper components, such as elastic members and fastening members, and surge layer may be assembled into the article by employing the above-identified attachment mechanisms. The article of the invention desirably includes the distinctive film or film laminate as a stretchable fabric layer as part of a stretchable outer cover which is operatively attached or otherwise joined to extend over a major portion of the outward surface of the article. In regions where the stretchable outer cover is not affixed to non-stretchable portions of the article or otherwise restricted from extending, the stretchable outer cover can be free to advantageously expand with minimal force.

In desired aspects, the outer cover can be stretchable along the longitudinal direction, lateral direction, or along a combination of both the lateral and longitudinal directions. In particular, it is desirable that at least the portion of the stretchable outer cover located in the waist sections be capable of extending in the lateral direction to provide improved fastening of the article about the wearers and improved coverage of the hips and buttocks of the wearer particularly in the rear waist section and enhanced breathability in the waist sections. For example, if the fasteners and or side panels are located along the side edges in the rear waist section of the diaper, at least a portion of the outer cover in the rear waist section will desirably extend to provide enhanced coverage over the buttocks of the wearer in use for improved containment and aesthetics. In a further alternative embodiment, the distinctive film of the invention may serve as a base material for stretchable ears/fastening tabs on the outer cover as well. In still another alternative embodiment of the present invention, the distinctive film may serve as the basis of a stretchable liner. In such an embodiment, the liner may be apertured. In still another alternative embodiment, the distinctive film may serve as a full stretchable outercover which encompasses both the front and rear areas of a personal care article, including stretchable side areas. This would eliminate the need to utilize distinct side panels in certain articles.

Moreover, it is also desirable that at least portions of the stretchable outer cover located over the absorbent body can extend during use for improved containment. For example, as the absorbent body absorbs fluid exudates and expands outwardly, the stretchable outer cover can readily elongate and extend in correspondence with the expansion of the absorbent body and/or other components of the article to provide void volume to more effectively contain the exudates. The stretchable outer cover of the present invention is desirably capable of providing a selected stretch when subjected to an applied tensile force, and the ability to retract upon removal of such applied force.

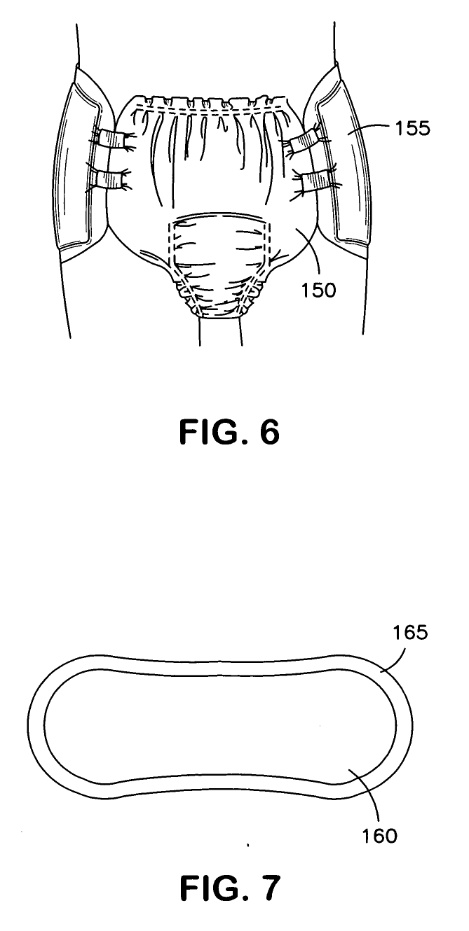

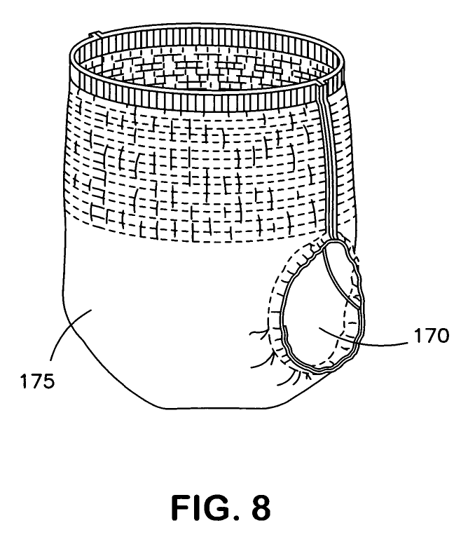

As can be seen in the various other absorbent personal care product embodiments, the inventive material may be used as an “outer cover” in a variety of product applications including a training pant, an underwear/underpant, feminine care product, and adult incontinence product. As an outercover, such material may be present in film form, or alternatively as a laminate in which a nonwoven or other sheet material has been laminated to the film layer. For instance, as can be seen in FIG. 5, the distinctive film can serve as the outer cover on both the back 135 and front portions of a training pant, separated by separate elastic side panels 140. As previously stated, such outercover may encompass the side panel areas in an alternative embodiment. As can be seen in FIG. 6, the distinctive film can serve as an outer cover in an underpant, such as either 150 or 155. As can be seen in FIG. 7, the distinctive film can serve as an outercover/backsheet 165 in a feminine care pantiliner 160. As can be seen in FIG. 8, the distinctive film can serve in an adult incontinence product as an outercover 175. Additionally such film or film laminates may serve as a sanitary napkin coversheet. Such film or film laminates may be further processed such as by being apertured and the like, before being used as base materials in such products.

A series of examples were developed to demonstrate and distinguish the attributes of the present invention. Such examples are not presented to be limiting, but in order to demonstrate various attributes of the inventive material. It should be noted that the first percentage listed reflects the volume percentage of the component in the extruded film. The second or third percentages reflect the weight percentage of that component that is a particular material. The example formulations in Table 1 are hypothetical in nature.

TABLE 1

| Component | Example 1 | Example 2 | Example 3 |
|---|---|---|---|
| 1^{st} skin layer | 2% LDPE with 1% AB. | 2% LDPE with 1% AB. | 2% LDPE with 1% AB. |
| 1^{st} Outer Core layer | 24% (Low viscosity | 24% (Low viscosity | 24% (low viscosity |
| | elastomer blend of 67% | elastomer blend of 67% | elastomer blend of 67% |
| | calcium carbonate filler, | calcium carbonate filler, | calcium carbonate filler, |
| | 26% KRATON ® G 1657 | 22% “KRATON DHV” | 26% KRATON ® G 1657 |
| | and 7% Dow PL 1280) | and 11% Dow PL 1280) | and 7% Dow Attane |
| | | | 4404G (4 Ml at 190° C.)) |
| Inner Core layer | 48% (high viscosity | 48% (high viscosity | 48% (high viscosity |
| | elastomer blend of 67% | elastomer blend of 67% | elastomer blend of 67% |
| | carbonate concentrate | carbonate concentrate | carbonate concentrate |
| | (75% calcium carbonate | (75% calcium carbonate | (75% calcium carbonate |
| | filler and 25% DOWLEX | filler and 25% DOWLEX | filler and 25% DOWLEX |
| | 2517 carrier resin) and 3 | 2517 carrier resin) and | 2517 carrier resin) and |
| | % polymer blend of (80% | 33% polymer blend of | 33% polymer blend of |
| | “KRATON DCP” and | (80% “KRATON DCP” | (80% “KRATON DCP” |
| | 20% KRATON ® G | and 20% KRATON ® G | and 20% KRATON ® G |
| | 1657)) | 1657)) | 1657)) |
| 2^{nd} Outer Core layer | 24% (Low viscosity | 24% (Low viscosity | 24% (low viscosity |
| | elastomer blend of 67% | elastomer blend of 67% | elastomer blend of 67% |
| | calcium carbonate filler, | calcium carbonate filler, | calcium carbonate filler, |
| | 26% KRATON ® G 1657 | 22% “KRATON DHV” | 26% KRATON ® G 1657 |
| | and 7% Dow PL 1280) | and 11% Dow PL 1280) | and 7% Dow Attane |
| | | | 4404G) |
| 2^{nd} skin layer | 2% LDPE mix (with 1% | 2% LDPE mix (with 1% | 2% LDPE mix (with 1% |
| | AB). | AB). | AB). |

Examples of antiblock material (AB) which may be used include Celite materials such as Celite 263 and Celite Superfloss available from the Celite Corporation. Antiblock materials may include diatomaceous earth that has been compounded with carrier resins such as for example 20 percent Celite 263 and 80 weight percent Dow AFFINITY EG 8185. Examples of actual films that have been made in accordance with the invention, including the performance attributes of such films, are reflected in Table 2. All of the samples were retracted 17.5% in production. None of the materials were corona treated.

TABLE 2

| | | | | | | Load | Load | | | |
|---|---|---|---|---|---|---|---|---|---|---|
| | | | | | | (gf) | (gf) @ | | | |
| | | | | | Basis | @ 50 | 50% | Load | 2^{nd} | |
| | | | | | Wt. | % Up | Down | Loss | Cycle | |
| | | | | | Stretch. | 1^{st} | 2^{nd} | (%) @ | Set | |
| | Layer | | | | Film | Cycle | Cycle | 50% | (%) | WVTR |
| Code | Ratio | Skin | Inner Core | Outer Core | (gsm) | CD | CD | CD | CD | (g/m²/24 hr) |
| 1 | 2/24/48/ | 4% Total | 48% total | 48% total | 32.5-32.8 | 380 | 188 | 50.4 | 15.6 | 2700 |
| | 24/2 | 93% Low | layer; 67% | layer; 67% | | | | | | |
| | | density PE, | (75% | (75% | | | | | | |
| | | 2% | Calcium | Calcium | | | | | | |
| | | antioxidant; | Carb. Filler | Carb. Filler | | | | | | |
| | | 5% | and 25% | and 25% | | | | | | |
| | | antiblock | LLDPE); | LLDPE); | | | | | | |
| | | (1% active | 33% (26.4% | 26% | | | | | | |
| | | AB) | “KRATON | KRATON ® | | | | | | |
| | | | DCP”, 6.6% | G 1657, 7% | | | | | | |
| | | | KRATON ® G | Dow PL | | | | | | |
| | | | 1657) | 1280 | | | | | | |
| 2 | 2/18/60/ | 4% Total | 48% total | 48% total | 32.7 | 393 | 206 | 47.6 | 13.4 | 2750 |
| | 18/2 | 93% Low | layer; 67% | layer; 67% | | | | | | |
| | | density PE, | (75% | (75% | | | | | | |
| | | 2% | Calcium | Calcium | | | | | | |
| | | antioxidant; | Carb. Filler | Carb. Filler | | | | | | |
| | | 5% | and 25% | and 2% | | | | | | |
| | | antiblock | LLDPE); | LLDPE); | | | | | | |
| | | (1% active | 33% (26.4% | 26% | | | | | | |
| | | AB) | “KRATON | KRATON ® | | | | | | |
| | | | DCP”, 6.6% | G 1657, 7% | | | | | | |
| | | | KRATON ® G | Dow PL | | | | | | |
| | | | 1657) | 1280 | | | | | | |
| 3 | 2/24/48/ | 4% Total | 48% total | 48% total | 31.8 | 381 | 201 | 47 | 13 | 2000 |
| | 24/2 | 93% Low | layer; 67% | layer; 67% | | | | | | |
| | | density PE, | (75% | (75% | | | | | | |
| | | 2% | Calcium | Calcium | | | | | | |
| | | antioxidant; | Carb. Filler | Carb. Filler | | | | | | |
| | | 5% | and 25% | and 25% | | | | | | |
| | | antiblock | LLDPE); | LLDPE); | | | | | | |
| | | (1% active | 33% (26.4% | 26% | | | | | | |
| | | AB) | “KRATON | KRATON ® | | | | | | |
| | | | DCP”, 6.6% | G 1657, 7% | | | | | | |
| | | | KRATON ® G | Dow Attane | | | | | | |
| | | | 1657) | 4404G | | | | | | |
| 4 | 2/18/60/ | 4% Total | 48% total | 48% total | 31 | 396 | 204 | 48 | 14 | 3300 |
| | 18/2 | 93% Low | layer; 67% | layer; 67% | | | | | | |
| | | density PE, | (75% | (75% | | | | | | |
| | | 2% | Calcium | Calcium | | | | | | |
| | | antioxidant; | Carb. Filler | Carb. Filler | | | | | | |
| | | 5% | and 25% | and 25% | | | | | | |
| | | antiblock | LLDPE); | LLDPE); | | | | | | |
| | | (1% active | 33% (26.4% | 26% | | | | | | |
| | | AB) | “KRATON | KRATON ® | | | | | | |
| | | | DCP”, 6.6% | G 1657, 7% | | | | | | |
| | | | KRATON ® G | Dow Attane | | | | | | |
| | | | 1657) | 4404G | | | | | | |

It should be noted that the LLDPE may be a single LLDPE or a blend of various LLDPEs, although a single LLDPE is particularly desirable. Such an LLDPE is exemplified by DOWLEX™ 2517. Desirably, in one embodiment, such improved films demonstrate a load up @ 50 percent extension (1st cycle) of between about 240 and 400 gf (3 inch wide sample). In an alternative embodiment, such films demonstrate a load down @ 50 percent retraction (2^{nd} cycle) of between about 150 and 225 gf. In still a third embodiment, such films demonstrate a hysteresis (2^{nd} cycle) of between about 33 and 40. In still a further embodiment, such films demonstrate a percent set (2^{nd} cycle ) of between about 11 and 16. In yet a further embodiment, such films demonstrate a breathability of greater than about 1000 g/m²/24 hrs.

In a third set of examples, films with and without distinct high and low viscosity layers were compared for processability advantages/disadvantages. The example codes are described in the following Table 3.

TABLE 3

| | | | Casting | Number of |
|---|---|---|---|---|
| | | | Roll | Breaks |
| Film Code | General | Basis | Speed | per hour in |
| Formulation | Description | Weight | (fpm) | process |
| 33% Septon 2004, | One layer | 33 gsm | 115 | 1 |
| 67% (75% CaCO₃, | | | | |
| 25% DOWLEX ™ | | | | |
| 2517) | | | | |
| 6.6% KRATON ® G | One Layer | 33 gsm | 100 | 4 |
| 1657, 26.4% | | | | |
| “KRATON DCP”, | | | | |
| 67% (75% CaCO₃, | | | | |
| 25% DOWLEX ™ | | | | |
| 2517) | | | | |
| ABA film die with | Three Layer | 33 gsm | 212 | <1 |
| 6% volume A, 88% | | | | |
| volume B, 6% | | | | |
| volume A, where A | | | | |
| is 33 wt % | | | | |
| KRATON ® G 1657, | | | | |
| 67% (75% CaCO₃, | | | | |
| 25% DOWLEX ™ | | | | |
| 2517) and B is 6.6 | | | | |
| wt % KRATON ® G | | | | |
| 1657, 26.4% | | | | |
| “KRATON DCP” | | | | |
| and 67% (75% | | | | |
| CaCO₃, 25% | | | | |
| DOWLEX ™ 2517) | | | | |

As a result of the direct comparisons, it can be seen that films with distinct high and low viscosity layers demonstrate considerably higher processing speeds (casting speeds) than those films without the layers (but with blends in one layer). Additionally, the films with distinct high and low viscosity layers demonstrated less film breakage during processing. Such processing advantages will ultimately provide benefit in lower production costs and material costs (from waste reduction).

While the invention has been described in detail with reference to specific embodiments thereof, it should be understood that many modifications, additions and deletions can be made thereto without departure from the spirit and scope of the invention as set forth in the following claims.

What is claimed is:

1. A breathable elastic multilayered film comprising: at least two skin layers including a low viscosity polymer, and a filler, wherein said each of said skin layers comprises between about 1 and 25 percent of the volume of said multilayered film; at least one core layer including a high viscosity polymer, a carrier resin and a filler, and further wherein said at least one core layer comprises between about 50 and 98 percent volume of said multilayered film, and being sandwiched by said at least two skin layers.

2. The breathable elastic multilayered film of claim 1, wherein each of said skin layers comprises between about 2 and 25 percent of the volume of said multilayered film and said core layer comprises between about 50 and 96 percent volume of said multilayered film.

3. The multilayered film of claim 1, wherein said low viscosity polymer demonstrates an MI of between about 6 and 25, and said high viscosity polymer demonstrates an MI of between about less than 1 and 4.

4. The multilayered film of claim 1, wherein said at least one core layer includes a high viscosity polymer and a lower viscosity polymer.

5. The multilayered film of claim 4, wherein said higher viscosity polymer and said lower viscosity polymer are present in a weight percent ratio of between about 3:1 to 4:1.

6. The multilayered film of claim 1 wherein the difference between MI of the low viscosity polymer and high viscosity polymer is at least about 5 MI.

7. The multilayered film of claim 6 wherein the difference between MI of the low viscosity polymer and high viscosity polymer is at least about 10 MI.

8. The multilayered film of claim 6 wherein the difference between MI of the low viscosity polymer and high viscosity polymer is at least about 15 MI.

9. The multilayered film of claim 1, wherein said skin layer comprises filler in a percentage of between about 10 and 50 weight percent.

10. The multilayered film of claim 1, wherein said core layer comprises two outer core layers and an inner core layer sandwiched between said two outer core layers.

11. The multilayered film of claim 10, wherein said outer core layers comprise a low viscosity elastomer and said inner core layer comprises a high viscosity elastomer.

12. A film and nonwoven layer laminate including the multilayered film of claim 1.

13. A film and nonwoven layer laminate including the multilayered film of claim 10.

14. A personal care article comprising the film and nonwoven layer laminate of claim 12.

15. A personal care article comprising the film and nonwoven layer laminate of claim 13.

16. The multilayered film of claim 1, wherein at least one of said skin layers includes a low viscosity elastomer.

17. A breathable elastic multilayered film comprising: at least two skin layers including a low viscosity polymer, and optionally a filler, wherein said each of said skin layers comprises between about 1 and 25 percent of the volume of said multilayered film; one inner core layer including a high viscosity polymer, a carrier resin and a filler, and further wherein said one inner core layer comprises between about 40 and 50 percent volume of said multilayered film; two outer core layers sandwiching said inner core layer, each of said outer core layers being positioned in said multilayered film immediately subjacent one of said skin layers, said outer core layers comprising a low viscosity polymer and comprising between about 12 and 25 percent volume of said multilayered film.

18. An elastic multilayered film comprising: at least two skin layers including a low viscosity polymer, wherein each of said skin layers comprises between about 1 and 25 percent of the volume of said multilayered film; at least one core layer including a high viscosity polymer, and further wherein said at least one core layer comprises between about 50 and 98 percent volume of said multilayered film, and being sandwiched by said at least two skin layers.
